(19) United States
(12) Patent Application Publication
(10) Pub. No.: US 2006/0104583 A1
(43) Pub. Date: May 18, 2006

(54) Method of fabricating ridge type waveguide integrated semiconductor optical device

(75) Inventors: Jong Hoi Kim, Daejeon (KR); Hyun Soo Kim, Daejeon (KR); Kang Ho Kim, Daejeon (KR); Oh Kee Kwon, Daejeon (KR); Eun Deok Sim, Daejeon (KR); Kwang Ryong Oh, Daejeon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/122,998

(22) Filed: May 6, 2005

(30) Foreign Application Priority Data
Nov. 18, 2004 (KR) 2004-94581

(51) Int. Cl. G02B 6/10

(52) U.S. Cl. 385/129

(57) ABSTRACT

Provided is a method of fabricating a ridge type waveguide integrated semiconductor optical device. The method includes: separating a substrate into an active waveguide region and a passive waveguide region and selectively epitaxial-growing an active layer and a passive layer in the active waveguide region and the passive waveguide region, respectively, such that the active layer and the passive layer are vertically aligned with each other; sequentially forming a capping layer and an electrode connection layer on the active layer and the passive layer; forming a first insulating layer pattern on a predetermined region of the electrode connection layer disposed in the active waveguide region and simultaneously, forming a second insulating layer pattern on a predetermined region of the electrode connection layer disposed in the passive waveguide region; forming a shallow ridge type active waveguide and a shallow ridge type passive waveguide by performing an etching process using the first and second insulating layer patterns as etch masks until the capping layer is etched to a predetermined depth; and forming a passivation pattern on the entire surface of the shallow ridge type active waveguide and forming a deep ridge type passive waveguide by performing an etching process using the second insulating layer pattern as an etch mask until the substrate is etched to a predetermined depth.

### CROSS-REFERENCE TO RELATED APPLICATION

This application claims priority to and the benefit of Korean Patent Application No. 2004-94581, filed Nov. 18, 2004, the disclosure of which is incorporated herein by reference in its entirety.

### BACKGROUND

1. Field of the Invention

The present invention relates to a method of fabricating a ridge type waveguide integrated semiconductor optical device and, more particularly, to a method of fabricating a ridge type waveguide integrated semiconductor optical device in which a deep ridge type passive waveguide and a shallow ridge active waveguide are automatically aligned with each other and integrated in a single device so that misalignments are removed to obtain high coupling efficiency, and insulating layers formed of the same material are used for the automatic alignment, thus enabling simplicity in performing the process.

2. Discussion of Related Art

In general, a deep ridge type passive waveguide integrated semiconductor optical device is fabricated by integrating an active waveguide having a shallow ridge type waveguide structure and a passive waveguide having a deep ridge type waveguide structure. The active waveguide can lower the cost of production because it is fabricated in a simple process. Also, the passive waveguide, which can minimize the radius of a curved waveguide, enables highly integrated devices to be fabricated.

However, the active waveguide and the passive waveguide cannot be formed at the same time owing to a difference in etch depth between the shallow ridge type waveguide structure and the deep ridge type waveguide structure, but are separately fabricated. In this process, the shallow and deep ridge type waveguide structures need to be aligned such that they combine with each other efficiently.

Hereinafter, a method of aligning different types of waveguides of a conventional deep ridge type waveguide integrated semiconductor optical device will be described.

An active layer and a passive layer are vertically aligned and sequentially epitaxial-grown on a substrate. An insulating layer, i.e., a silicon nitride (Si₃N₄) dielectric thin layer, is deposited on the entire surface of the substrate and etched, thereby forming a waveguide mask. Thereafter, the substrate is primarily etched so that a shallow ridge type waveguide is obtained.

A silicon oxide (SiO₂) dielectric thin layer is deposited on the entire surface of the resultant structure and etched such that the SiO₂ dielectric thin layer disposed in an active layer region excluding a passive layer region is removed. Likewise, the substrate is secondarily etched so that a deep ridge type structure is derived from the shallow ridge type structure disposed in the active layer region. After that, the active layer region is buried, and an electrode is formed thereon, thereby completing the active waveguide in which the deep ridge type waveguide is integrated.

The foregoing conventional device has good performance by automatically aligning an active waveguide and a passive waveguide so as to remove misalignments. However, dielectric thin layers made of different materials are used for etch masks, and respective mask forming processes should be separately performed. Accordingly, the number of processes increases and the entire fabricating process becomes complicated.

### SUMMARY OF THE INVENTION

The present invention is directed to a method of fabricating a ridge type waveguide integrated semiconductor optical device in which a deep ridge type waveguide and an active waveguide are automatically aligned and integrated in a single device so that no misalignment occurs to improve coupling efficiency, and insulating layers formed of the same material are used for the automatic alignment, thus simplifying the process.

One aspect of the present invention is to provide a method of fabricating a ridge type waveguide integrated semiconductor optical device comprising: separating a substrate into an active waveguide region and a passive waveguide region and selectively epitaxial-growing an active layer and a passive layer in the active waveguide region and the passive waveguide region, respectively, such that the active layer and the passive layer are vertically aligned with each other; sequentially forming a capping layer and an electrode connection layer on the active layer and the passive layer; forming a first insulating layer pattern on a predetermined region of the electrode connection layer disposed in the active waveguide region and simultaneously, forming a second insulating layer pattern on a predetermined region of the electrode connection layer disposed in the passive waveguide region; forming a shallow ridge type active waveguide and a shallow ridge type passive waveguide by performing an etching process using the first and second insulating layer patterns as etch masks until the capping layer is etched to a predetermined depth; and forming a passivation pattern on the entire surface of the shallow ridge type active waveguide and forming a deep ridge type passive waveguide by performing an etching process using the second insulating layer pattern as an etch mask until the substrate is etched to a predetermined depth.

Epitaxial-growing the active layer and the passive layer in the active waveguide region and the passive waveguide region, respectively, such that the active layer and the passive layer are vertically aligned with each other may include growing an active layer on the substrate and removing the active layer disposed in the passive waveguide region using a wet or dry etching process; and growing a passive layer in the passive waveguide region from which the active layer is removed, such that the active layer and the passive layer are vertically aligned with each other.

The first and second insulating layer patterns may be formed of the same material.

After forming the first and second insulating layer patterns simultaneously, the method of the present invention may further include burying the active waveguide region and forming a predetermined electrode on the resultant structure.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIGS. 1A through 1G are cross sectional views illustrating a method of fabricating a ridge type waveguide integrated semiconductor optical device according to an embodiment of the present invention; and

FIG. 2 is a flow chart illustrating a method of fabricating a ridge type waveguide integrated semiconductor optical device according to an embodiment of the present invention.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure is thorough and complete and fully conveys the scope of the invention to those skilled in the art.

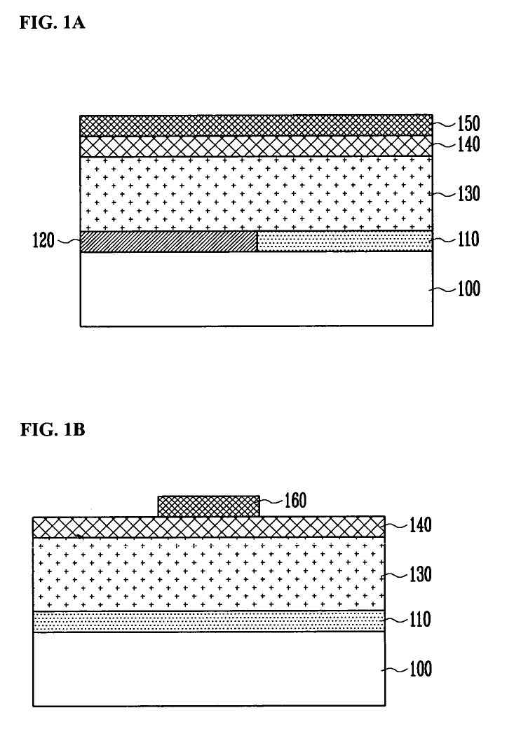

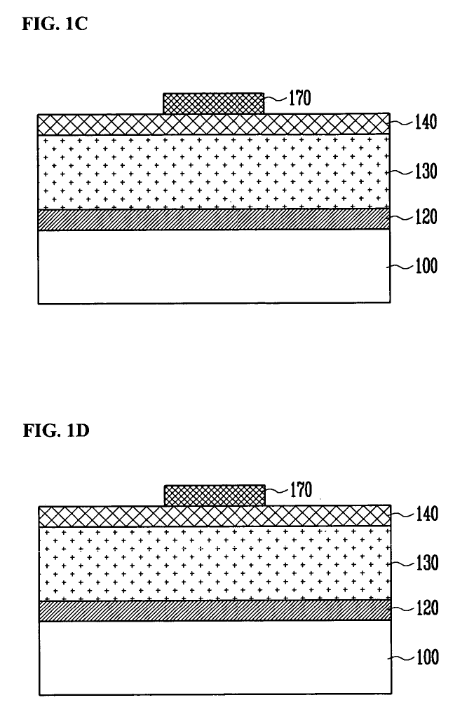

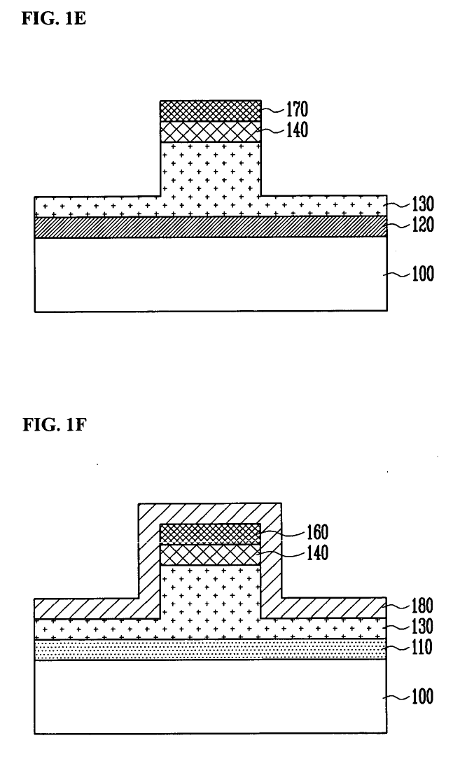

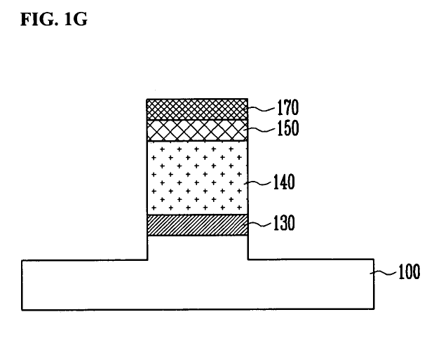

FIGS. 1A through 1G are cross sectional views illustrating a method of fabricating a ridge type waveguide integrated semiconductor optical device according to an embodiment of the present invention.

Referring to FIG. 1A, an active layer 110 is grown on a substrate 100, and the active layer 110 disposed in a passive waveguide region is removed using a dry or wet etching process for semiconductor materials. A passive layer 120 is grown on the passive waveguide region from which the active layer 110 is removed, such that the passive layer 120 is vertically aligned with the active layer 110. Thereafter, a capping layer 130 and an electrode connection layer 140 are sequentially grown on the resultant structure. An insulating layer 150, for example, a Si₃N₄ thin layer, is deposited on the electrode connection layer 140.

Referring to FIGS. 1B and 1C, a first insulating layer pattern 160 is formed on a predetermined region of the electrode connection layer 140 disposed in a region where the active layer 110 is formed, namely, an active waveguide region, and simultaneously, a second insulating layer pattern 170 is formed on a predetermined region of the electrode connection layer 140 disposed in the passive waveguide region.

In this case, the first and second insulating layer patterns 160 and 170 are formed of the same material, for example, a Si₃N₄ thin layer, and may be formed using a dry or wet etching process for Si₃N₄.

Referring to FIGS. 1D and 1E, by using the first and second insulating layer patterns 160 and 170 as etch masks, for instance, a dry or wet etching process for semiconductor materials is performed until the capping layer 130 is etched to a predetermined depth. Thus, a shallow ridge type active waveguide and a shallow ridge type passive waveguide are formed.

Referring to FIG. 1F, for example, a Si₃N₄ thin layer is deposited on the entire surface of the resultant structure, and a passivation pattern 180 for protecting the shallow ridge type active waveguide is formed thereon. In this case, the Si₃N₄ thin layer disposed in the passive waveguide region is removed, while a photoresist (PR) mask (not shown) disposed on the passivation pattern 180 remains intact.

In this process, a time taken to perform the dry or wet etching process for removing, for example, Si₃N₄, is set such that the Si₃N₄ thin layer disposed in the passive waveguide region is sufficiently removed but the second insulating layer pattern 170 still remains.

Referring to FIG. 1G, by using the second insulating layer pattern 170 as an etch mask, for example, a dry or wet etching process for semiconductor materials is performed until the substrate 100 is etched to a predetermined depth. Thus, a deep ridge type passive waveguide is obtained.

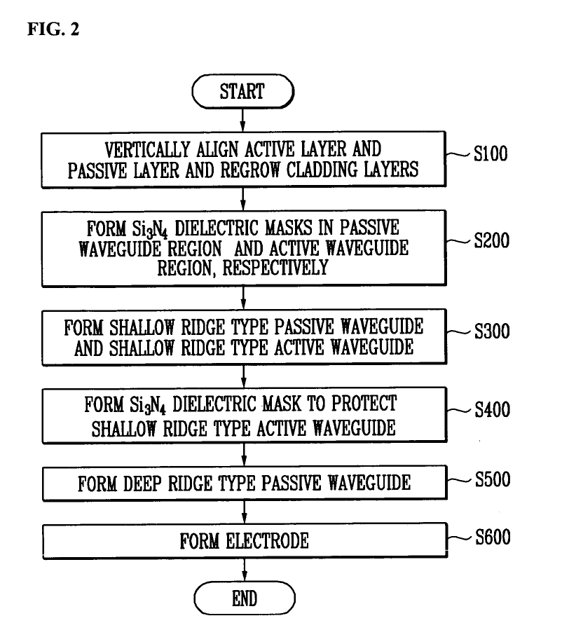

FIG. 2 is a flow chart illustrating a method of fabricating a ridge type waveguide integrated semiconductor optical device according to an embodiment of the present invention.

Referring to FIG. 2, in operation S100, an active layer 110 and a passive layer 120 are epitaxial-grown on selective regions of a substrate 100 and vertically aligned with each other, and then a capping layer 130 and an electrode connection layer 140 are sequentially grown on the resultant structure.

In operation S200, an insulating layer 150 (e.g., a Si₃N₄ thin layer) is deposited on the electrode connection layer 140, and a first insulating layer pattern 160 (i.e., a Si₃N₄ dielectric mask) is formed in an active waveguide region and simultaneously, a second insulating layer pattern 170 (i.e., a Si₃N₄ dielectric mask) is formed in a passive waveguide region.

An etching process is performed, thereby forming a shallow ridge type passive waveguide and a shallow ridge type active waveguide in operation S300. Thereafter, for instance, a Si₃N₄ thin layer is deposited on the entire surface of the resultant structure, and a passivation pattern 180 (i.e., a Si₃N₄ dielectric mask) for protecting the shallow ridge type active waveguide is formed thereon in operation S400.

In operation S500, an etching process is performed such that a deep ridge type passive waveguide is obtained. Subsequently, for example, a Si₃N₄ thin layer is deposited on the entire surface of the resultant structure, the Si₃N₄ thin layer disposed on the shallow ridge type active waveguide is removed, and a predetermined electrode is formed thereon in operation S600.

According to the present invention as described above, a deep ridge type waveguide and an active waveguide are automatically aligned with each other and integrated in a single device. Thus, no misalignment occurs, thereby enhancing coupling efficiency, and insulating layers formed of the same material are used for the automatic alignment, thus simplifying the process. As a consequence, an optical integrated circuit (IC) device can be highly integrated and efficient, and the cost of production is reduced.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

What is claimed is:

1. A method of fabricating a ridge type waveguide integrated semiconductor optical device, comprising:
a) separating a substrate into an active waveguide region and a passive waveguide region and selectively epitaxial-growing an active layer and a passive layer in the active waveguide region and the passive waveguide region, respectively, such that the active layer and the passive layer are vertically aligned with each other;
b) sequentially forming a capping layer and an electrode connection layer on the active layer and the passive layer;
c) forming a first insulating layer pattern on a predetermined region of the electrode connection layer disposed in the active waveguide region and simultaneously, forming a second insulating layer pattern on a predetermined region of the electrode connection layer disposed in the passive waveguide region;
d) forming a shallow ridge type active waveguide and a shallow ridge type passive waveguide by performing an etching process using the first and second insulating layer patterns as etch masks until the capping layer is etched to a predetermined depth; and
e) forming a passivation pattern on an entire surface of the shallow ridge type active waveguide and forming a deep ridge type passive waveguide by performing an etching process using the second insulating layer pattern as an etch mask until the substrate is etched to a predetermined depth.

2. The method according to claim 1, wherein the step a) includes:
a1) growing an active layer on the substrate and removing the active layer disposed in the passive waveguide region using one of a wet etching process and a dry etching process; and
a2) growing a passive layer in the passive waveguide region from which the active layer is removed, such that the active layer and the passive layer are vertically aligned with each other.

3. The method according to claim 1, wherein the first insulating layer pattern and the second insulating layer pattern are formed of the same material.

4. The method according to claim 3, wherein each of the first insulating layer pattern and the second insulating layer pattern is formed of a silicon nitride (Si₃N₄) thin layer.

5. The method according to claim 1, further comprising, after the step c), burying the active waveguide region and forming a predetermined electrode on the resultant structure.
